(19) United States
(12) Patent Application Publication
(10) Pub. No.: US 2011/0191243 A1
(43) Pub. Date: Aug. 4, 2011

(54) Automated Teller Machine Load Balancing

(75) Inventor: Morgan S. Allen, Charlotte, NC (US)

(73) Assignee: Bank of America Corporation, Charlotte, NC (US)

(21) Appl. No.: 12/700,155

(22) Filed: Feb. 4, 2010

(51) Int. Cl. G06Q 10/00; G06Q 40/00

(52) U.S. Cl. 705/43; 705/7.25

(57) ABSTRACT

A system and method of balancing load between one or more ATMs is provided. In some examples, a notification of a service issue may be received from a first ATM. A determination may be made as to whether ATMs within a predefined geographic distance of the first ATM may have sufficient capacity to support additional transactions due to the first ATM being out of service. If the additional ATMs do have sufficient capacity, a service call to address the service issue at the first ATM may be postponed, for instance, until a more convenient time, a regular business day, etc. If the additional ATMs in the area do not have sufficient capacity, a service call may be placed to address the service issue at the first ATM as soon as possible.

### BACKGROUND

Today's banking industry is in a state of flux. As the economic conditions continue to fluctuate, the banking and financial services industries are striving to remain profitable. Accordingly, banks and other financial institutions are shifting transactions and other services to the least costly channels. For instance, conducting a transaction at a bank teller is more costly to the bank or financial institution than conducting the transaction at an Automated Teller Machine (ATM). Accordingly, banks are attempting to provide increased functionality and ease of use at ATM's to encourage customers and other users to conduct transactions at ATM's rather than through more traditional channels.

However, this increased use of ATMs may result in additional malfunctions, service calls, etc. These service calls can be costly and time consuming, particularly if a malfunction or break down occurs on a weekend, holiday, etc. Accordingly, a system and method of determining whether an immediate service call should be placed to repair an ATM or whether other ATMs within a predetermined proximity to the ATM requiring service have sufficient funds, etc. to compensate for the loss of that ATM for a period of time would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a notification of a service issue may be received from a first ATM. In some examples, a determination may be made as to whether ATMs within a predefined geographic distance of the first ATM may have sufficient capacity to support additional transactions due to the first ATM being out of service. If the additional ATMs do have sufficient capacity, a service call to address the service issue at the first ATM may be postponed, for instance, until a more convenient time, a regular business day, etc. If the additional ATMs in the area do not have sufficient capacity, a service call may be placed to address the service issue at the first ATM as soon as possible.

In other aspects, a notification of low funds at a first ATM may be received. In some examples a determination may be made as to whether a replenishment is scheduled within a predetermined time period. If a replenishment is not scheduled within the predetermined time period, a determination is made as to whether sufficient capacity is available at another ATM within a predefined geographic distance of the first ATM. If sufficient capacity is available the scheduled replenishment may take place.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example ATM environment according to one or more aspects described herein.

FIG. 3 illustrates one example ATM environment including ATMs within a predefined area that may be in communication with each other or may work cooperatively according to one or more aspects described herein.

FIG. 4 illustrates one example method of ATM load balancing according to one or more aspects described herein.

FIG. 5 illustrates another example method of ATM load balancing according to one or more aspects described herein.

FIG. 6 illustrates yet another example method of ATM load balancing according to one or more aspects described herein.

FIG. 7 illustrates one example user interface providing locations of alternate ATMs in accordance with one or more aspects described herein.

FIG. 8 illustrates one example user interface providing information regarding limited functionality at an ATM in accordance with one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

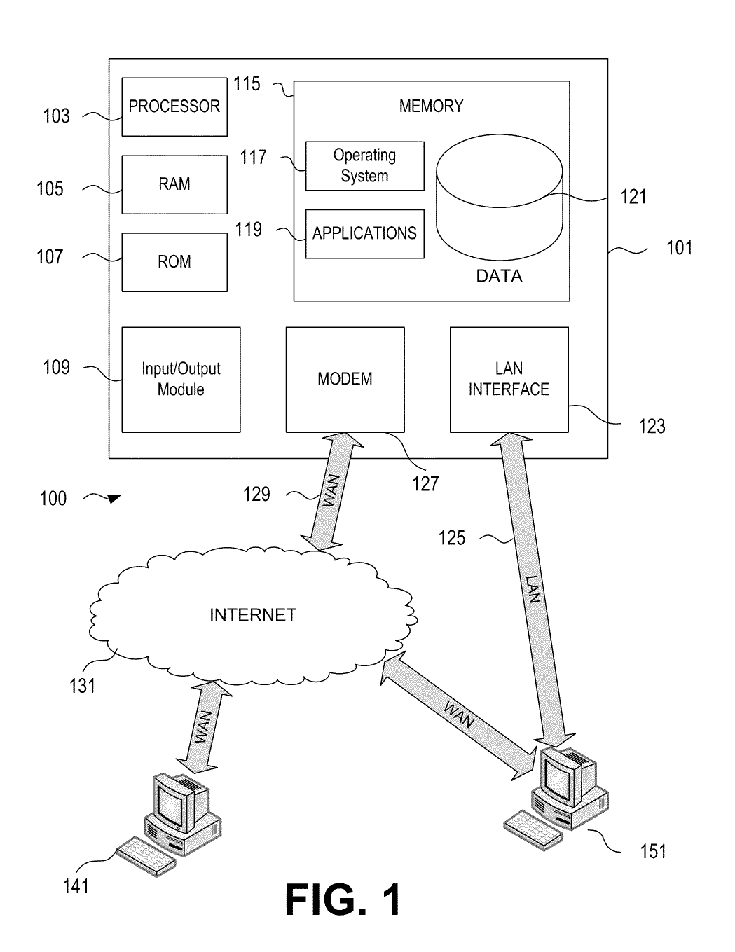

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

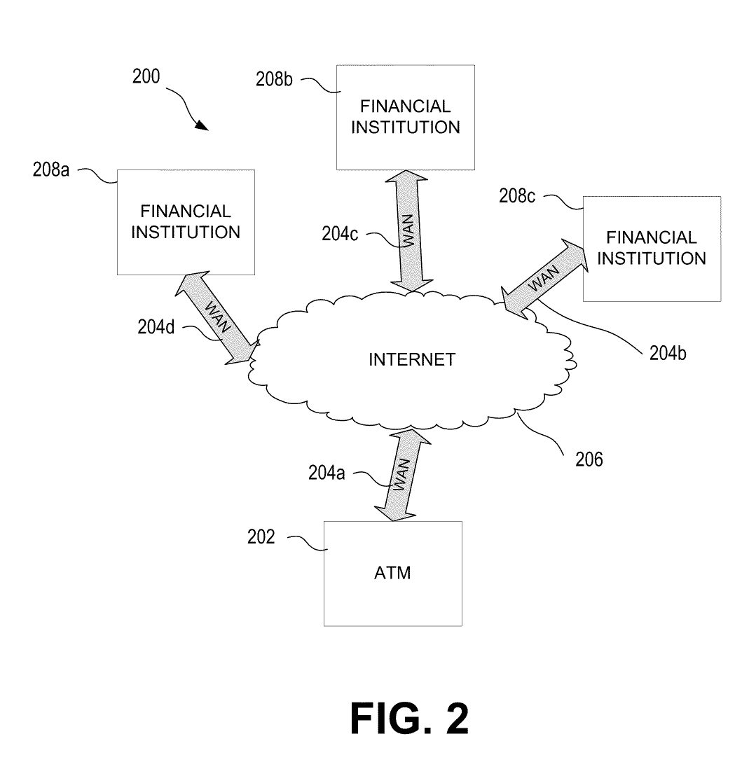

The systems, devices, networks, etc. of FIG. 1 may, in one or more arrangements, be used to provide functionality to one or more cash handling devices, such as an automated teller machine (ATM). ATMs are commonly used to provide access to financial transactions without requiring an individual, such as a bank teller, to complete the transaction. ATMs are often associated with one or more financial institutions, however, typical ATMs are accessible to both customers of the associated financial institution and non-customers, sometimes for a fee. One example ATM environment 200 is shown in FIG. 2. The ATM 202 is connected, via WAN, LAN, etc. 204a-204d to a network 206, such as the Internet, to communicate with one or more financial institutions 208a-208c. One of financial institutions 208a-208c, such as financial institution 208a, may be associated with the ATM 202 while the others, such as financial institutions 208b, 208c may not be associated with the ATM 202 but may communicate with the ATM 202 to complete transactions by customers associated with the financial institutions 208b, 208c and conducted at the ATM 202.

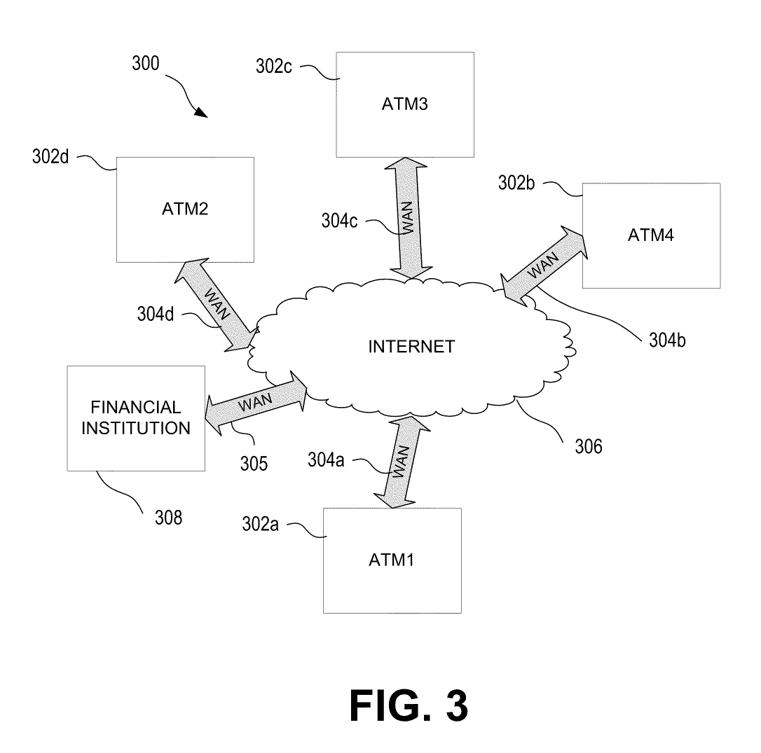

In some instances, a financial institution may have several ATMs with which it is associated distributed about a geographic area. For instance, FIG. 3 illustrates one example computing environment in which a plurality of ATMs 302a-302d are in communication with each other (such as via WAN 304a-304d) via a network 306, such as the Internet. Further, the financial institution 308 with which the ATMs 302a-302d are associated may also be connected to the network 306, such as via WAN 305 to permit communication between each ATM and the financial institution. In some examples, the status of one or more ATMs 302a-302d, capacity available at one or more ATMs 302a-302d, etc. may be communicated to or known by other ATMs 302a-302d and/or the financial institution. Accordingly, the availability of funds, functionality, etc. within the geographic area of the ATMs 302a-302d may be known. This information may be used to balance the load (transactions, etc.) associated with the ATMs.

In some examples, the ATMs 302a-302d may be dispersed within a predefined geographic area to allow for cooperation between the ATMs 302a-302d. For instance, the ATMs may be in communication in order to transmit when one ATM is out of service or has reduced functionality do to running out of funds, malfunction (paper jam, etc.). One ATM being out of service may cause an increase in transaction activity at other ATMs, particularly those located close by (i.e., geographically close to) the ATM that is out of service or requiring service. In some examples, arrangements may be made to accommodate this potential increase in activity. Additionally or alternatively, if a service call (such as providing additional funds, repairing the malfunctioning machine, etc.) is required for the out of service or limited service ATM, the timing of that service call may be adjusted based on the available capacity, functionality, etc. of the other ATMs within the area.

For instance, service calls may be costly, particularly on a weekend, holiday, etc. Service calls can also be inconvenient, time consuming, etc. If sufficient capacity and/or functionality exists in nearby ATMs, that information may be communicated to a central server, the financial institution, etc. in order to appropriately schedule the service call. In some arrangements, the service call may be delayed, postponed or cancelled based on the status of the other nearby ATMs, day of the week, date (e.g., holiday such as July 4), etc. For example, a service call on a Sunday to provide additional funds to an ATM that has depleted its funds may not be worthwhile if other ATMs in the area have sufficient capacity to compensate for the unavailability of funds at this ATM and/or because the funds may be scheduled to be replenished on Monday morning. Alternatively, if an ATM malfunctions on a Friday evening and other ATMs within the geographic area may not have capacity to compensate for the out of service ATM, a service call may be placed to have the ATM malfunction addressed as soon as possible to provide functionality throughout the weekend if possible. Various other date, day of the week, etc. scenarios may be considered in scheduling maintenance, etc. without departing from the invention. The examples discussed herein are merely a few example scenarios.

In some examples, ATMs may be grouped or a cluster of ATMs within a certain geographic region may be identified. The geographic region may be comprised of a predefined number of city blocks (for instance, all ATMs 302a-302d are located within ten (10) blocks of point A, twenty (20) blocks of point A, five (5) blocks of point A, etc.). Additionally or alternatively, the ATMs 302a-302d may be located within a predefined linear distance, such as yards, feet, miles, etc. from a reference point. For example, the ATMs 302a-302d may be located within 500 yards of point A, ½ mile of point A, 1000 feet of point A, etc. The determination of point A may be randomly selected, may be selected to provide a cluster of ATMs within an area, etc.

The cluster of ATMs, such as ATMs 302a-302d in FIG. 3, may work together to provide efficient customer service and functionality. For example, the ATMs 302a-302d may share information, data, etc. in order to cooperate in balancing the load associated with some of all of the ATMs within the cluster. For instance, in situations in which one ATM, such as ATM 302a, has run out of funds to distribute or has malfunctioned (paper jam, etc.), the remaining ATMs 302b-302d within the predefined distance (such as the cluster described above) may receive notice of the service issue at ATM 302a and may expect increased transaction activity due to ATM 302a being out of service. The expectation of increased functionality may include providing only certain denominations of bills in withdrawals in order to reserve funds within the ATMs 302b-302d, scheduling replenishment of funds, etc.

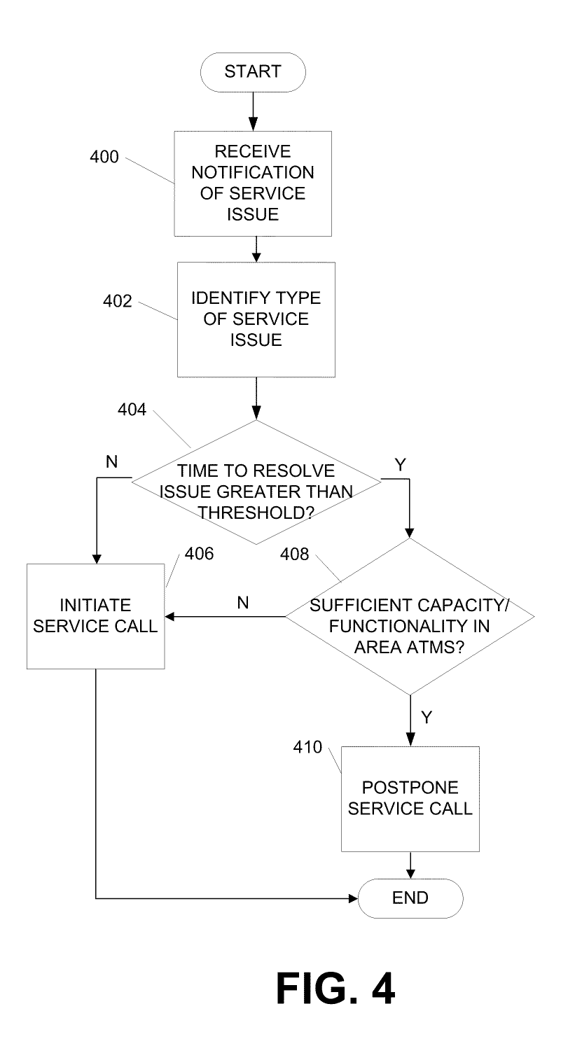

FIG. 4 illustrates one example method of ATM load balancing according to aspects described herein. In step 400 a notification is received of a service issue at an ATM. For instance, an ATM within a predefined geographic region may transmit a notification to a central server, financial institution, etc. of a service issue. In step 402, the type of service issue may be identified. For instance, a service issue may include a malfunction, request for replenishment of funds, etc. The type of service issue may dictate how urgent the need for service is, in some examples. Identifying the type of service may, in some examples, be an automated process or performed automatically without user input. In step 404 a determination is made regarding whether the time to resolve the issue is greater than a predetermined threshold. For instance, if the service issue is one that may be relatively quick to resolve (e.g., based on the type of service issue) the time to resolve may be less than a predetermined threshold. In some examples, the predetermined threshold may be between 1 and 3 hours, 2 and 5 hours, or, in some instances one day. This determination may, in some examples, be automated or performed automatically and may not include user input or assistance. If the time to resolve the issue is not greater than the predetermined threshold (for instance, it may be relatively quick to fix) the service call may be initiated in step 406. Alternatively, if the time to resolve the issue is greater than the predetermined threshold a determination may be made as to whether there is sufficient capacity and/or functionality in other ATMs within the predefined area to offset the loss of the ATM needing service in step 408. Sufficient capacity may include capacity above a predetermined threshold, for instance, the ATM includes more than a minimum number of bills of each denomination, sufficient receipt paper, sufficient currency deposit canister capacity, sufficient check deposit canister capacity, sufficient coin deposit canister capacity, sufficient coin collection canister capacity, etc. This determination may, in some examples, be automated or performed automatically such that no additional user input is necessary to make the determination. If there is not sufficient capacity/functionality a service call may be initiated, as in step 406. However, if sufficient capacity and/or functionality is available in other ATMs within the predefined area, the service call may be postponed in step 410. This step may be performed automatically such that no additional user input is required.

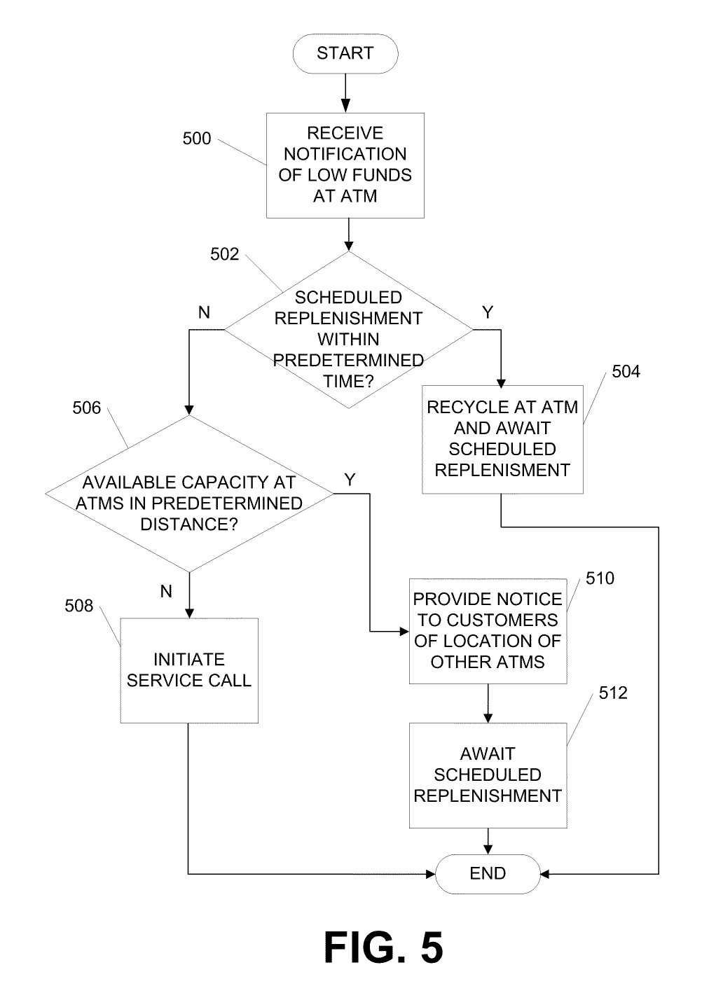

FIG. 5 illustrates another method of load balancing between ATMs according to one or more aspects described herein. In step 500 a notification of low funds at an ATM is received, for instance, at a central server, financial institution, etc. In step 502, a determination is made as to whether a replenishment of funds is scheduled within a predetermined time. In some examples, the predetermined time may be between 24 and 36 hours. If the scheduled replenishment is within the predetermined time, the ATM may be configured to act as a cash recycler in step 504 and that mode may be activated and the scheduled replenishment may take place. For instance, in acting as a cash recycler, bills deposited into the ATM may be available to be withdrawn, in some cases immediately. This arrangement may provide additional capacity to the machine since deposited funds may be available for withdrawal by any user.

If the scheduled replenishment is not within the predetermined time a determination is made in step 506 as to whether there is available capacity at ATMs within a predefined distance from the ATM indicating low funds. If sufficient capacity is not available at the other ATMs, a service call may be initiated in step 508. Alternatively, if sufficient capacity is available at other area ATMs, the ATM having low funds may provide an indication to customers of low funds and provide locations of the other ATMs within the predefined area in step 510. The scheduled service call (replenishment) may be awaited in step 512 while the sufficient capacity is available at other area ATMs. The method steps illustrated in FIG. 5 may, in some examples, be automated, or performed automatically, such that no or minimal user input is necessary.

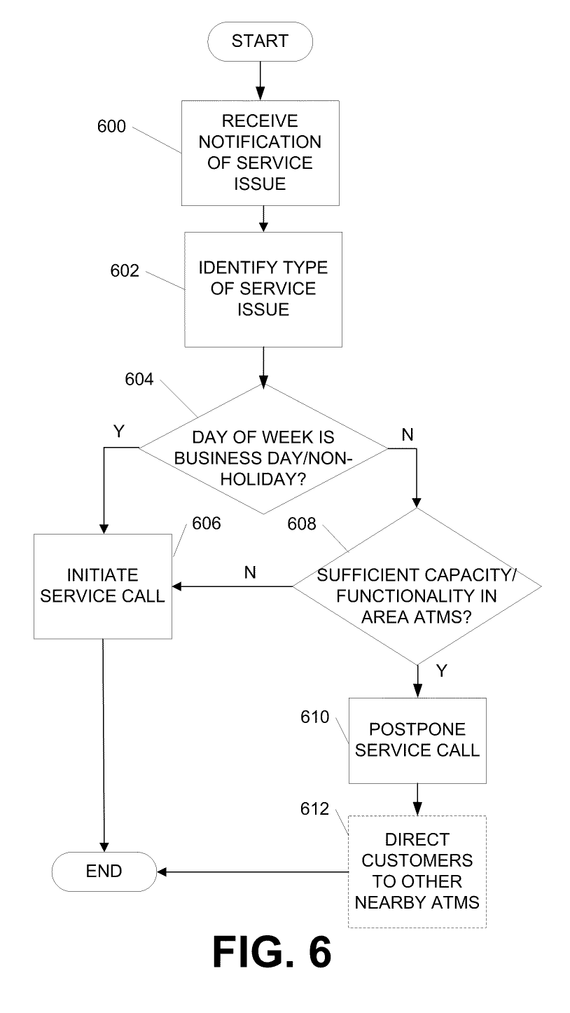

FIG. 6 illustrates yet another example of ATM load balancing according to aspects described herein. In step 600 a notification of a service issue is received. In step 602, the type of service issue is identified. In step 604 a determination is made as to whether the day of the week is a business day and/or non-holiday. If the day of the week is a business day, a service call may be initiated in step 606. Initiating the service call on a business day may save costs associated with the service call because no overtime, etc. would be paid to a service person.

If the day is a non-business day, such as a weekend and/or a holiday, a determination is made in step 608 as to whether there is sufficient capacity/functionality available in other ATMs within a predefined area or region to support the loss of the ATM having the service issue. If there is not sufficient capacity in the other area ATMs a service call may be initiated, as in step 606. If sufficient funds are available, the service call may be postponed in step 610. Postponing the service call may include postponing initiation of the service call until the next business day. In optional step 612, the ATM having the service issue may provide a notification to customers of other ATMs within the predefined area and their locations. The steps of the method illustrated in FIG. 6 may, in some examples, be performed automatically such that little or no user input is necessary to perform one or more of the steps.

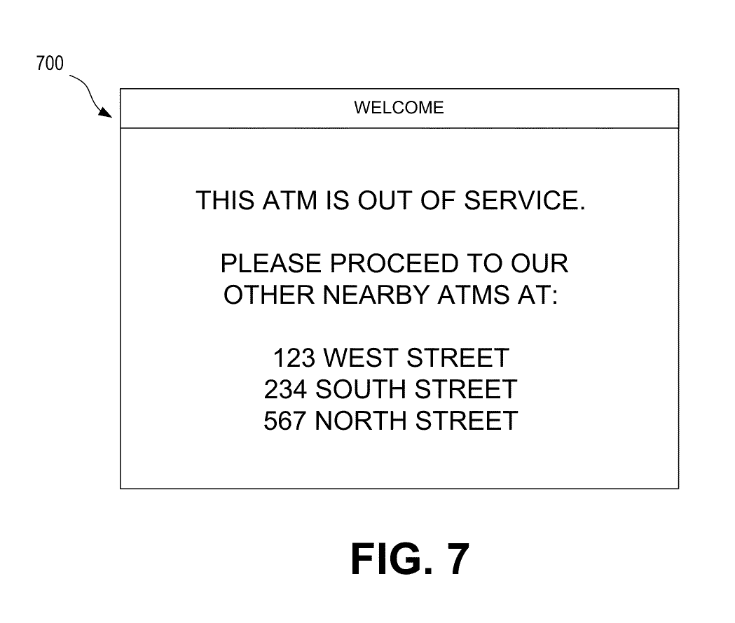

FIG. 7 illustrates one example user interface providing a notification to a user that the ATM is out of service. Interface 700 includes a notification that this particular ATM is out of service and also provides locations of other nearby ATMs at which the user may conduct transactions.

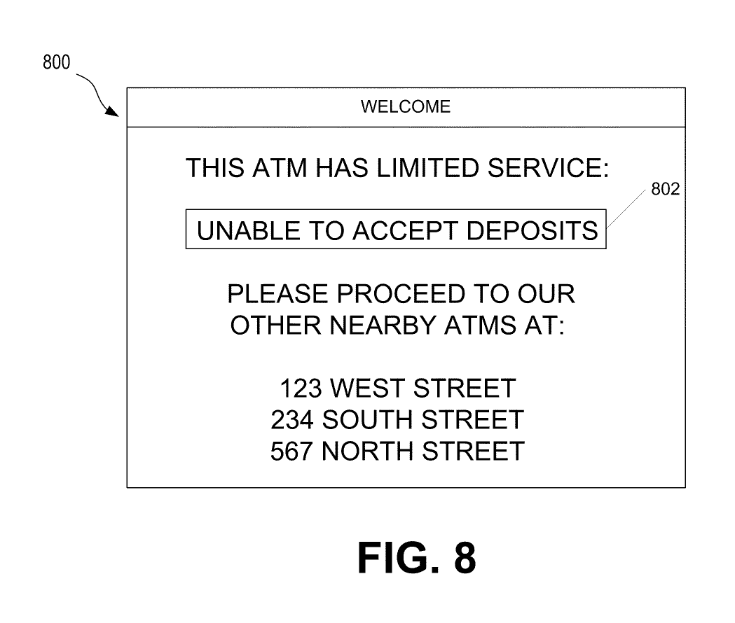

FIG. 8 illustrates one example user interface providing limited service information for an ATM. Interface 800 includes a notification that the ATM has limited service. For instance, interface 800 includes available function field 802 which indicates that this ATM is currently unable to accept deposits. Various other service limitations may be listed, such as “only able to accept deposits,” “no coin available,” “no receipt available,” etc. These examples are merely a few examples of various service limitations. However, by indicating what services are available, or unavailable, at the ATM, a user desiring a particular service may determine whether the ATM will be able to process their transaction or if they should visit another nearby ATM. Further, providing an indication of the limited services available aids in permitting the ATM to remain available for some functions, rather than being identified as completely out of service.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method, comprising:
receiving an indication of a service issue at a first ATM;
determining if a time to service the first ATM is greater than a predetermined threshold;
responsive to determining that the time to service the first ATM is greater than the predetermined threshold, determining whether at least a second ATM within a predetermined geographic distance from the first ATM has sufficient capacity; and
responsive to determining that the at least second ATM has sufficient capacity, delaying service of the first ATM.

2. The method of claim 1, wherein the predetermined geographic distance is a predetermined number of city blocks between the first ATM and the at least second ATM.

3. The method of claim 1, wherein the predetermined geographic distance is a predetermined number of yards between the first ATM and the at least second ATM.

4. The method of claim 1, further comprising determining a day of a week for on which the service issue occurred; and
responsive to determining that the day of the week is a non-business day, delaying service of the first ATM until a next business day.

5. The method of claim 1, wherein sufficient capacity of the at least second ATM includes capacity above a predetermined threshold.

6. The method of claim 5, wherein the predetermined threshold is a minimum number of bills of a denomination.

7. A method, comprising:
receiving a notification of low funds at a first ATM;
determining whether a replenishment is scheduled within a predetermined time period;
responsive to determining that the replenishment is not schedule within the predetermined time period, determining whether sufficient capacity is available at least a second ATM within a predefined geographic distance of the first ATM;
responsive to determining that sufficient capacity is available at the at least second ATM, awaiting the scheduled replenishment.

8. The method of claim 7, further including:
responsive to determining that the replenishment is scheduled within the predetermined time period, initiating a cash recycler mode at the first ATM and awaiting the scheduled replenishment.

9. The method of claim 8, wherein cash recycler mode enables the first ATM to function as a cash recycler.

10. The method of claim 9, wherein bills deposited into the first ATM may be withdrawn when the first ATM is in cash recycler mode.

11. The method of claim 7, further including:
responsive to determining that sufficient capacity is not available at the at least second ATM, initiating a service call.

12. The method of claim 11, wherein initiating the service call including requesting a replenishment of funds.

13. The method of claim 7, further including:
responsive to determining that sufficient capacity is available at the at least second ATM, providing a notification of a location of the at least second ATM.

14. The method of claim 7, further including:
responsive to determining that the scheduled replenishment is not within the predetermined time, determining whether a day on which the low funds notification was received is a business day.

15. The method of claim 14, further including:
responsive to determining that the day of the week is a business day, initiating a service call.

16. One or more computer readable media storing computer readable instructions that, when executed, cause an apparatus to:
receive an indication of a service issue at a first ATM;
determine if a time to service the first ATM is greater than a predetermined threshold;
responsive to determining that the time to service the first ATM is greater than the predetermined threshold, determine whether at least a second ATM within a predetermined geographic distance from the first ATM has sufficient capacity; and
responsive to determining that the at least second ATM has sufficient capacity, delay service of the first ATM.

17. The one or more computer readable media of claim 16, wherein the predetermined geographic distance is a predetermined number of city blocks between the first ATM and the at least second ATM.

18. The one or more computer readable media of claim 16, wherein the predetermined geographic distance is a predetermined number of yards between the first ATM and the at least second ATM.

19. The one or more computer readable media of claim 16, wherein the computer readable instructions, when executed, further cause the apparatus to:
determine a day of a week for on which the service issue occurred; and
responsive to determining that the day of the week is a non-business day, delay service of the first ATM until a next business day.

20. The one or more computer readable media of claim 16, wherein sufficient capacity of the at least second ATM includes capacity above a predetermined threshold.

21. The one or more computer readable media of claim 20, wherein the predetermined threshold is a minimum number of bills of a denomination.
